(19) United States
(12) Patent Application Publication
(10) Pub. No.: US 2026/0044761 A1
(43) Pub. Date: Feb. 12, 2026

(54) SELF-ADJUSTING FUZZY LOGIC APPLICATION

(71) Applicant: INTERNATIONAL BUSINESS MACHINES CORPORATION, Armonk, NY (US)

(72) Inventors: Pierre C. Berlandier, San Diego, CA (US); Swaminathan Balasubramanian, Troy, MI (US); Renganathan Sundararaman, Cary, NC (US); Rajiv Joshi, Yorktown Heights, NY (US)

(21) Appl. No.: 18/800,197

(22) Filed: Aug. 12, 2024

(51) Int. Cl. G06N 7/02

(52) U.S. Cl. CPC G06N 7/02

(57) ABSTRACT

A computer hardware fuzzy logic system includes a controlled system and a fuzzy logic application configured to control the controlled system. A dataset defined by a period of time is retrieved from a store of historical input values for the controlled system. K clusters are generated from the dataset, and new fuzzy set definitions are generated for the K clusters. The fuzzy logic application updates old fuzzy set definitions with the new fuzzy set definitions. The fuzzy logic application also generates variable adjustments to the control system using the new fuzzy set definitions and received input values for the controlled system. The controlled system is modified using the variable adjustments.

### BACKGROUND

The present invention relates to fuzzy logic applications, and more specifically, to self-adjusting of fuzzy set definitions within a fuzzy logic application.

Fuzzy logic is used in a wide range of technical applications, such as control systems, image processing, natural language processing, and artificial intelligence. These are referred to herein as “controlled systems.” For example, in aerospace, fuzzy logic applications can be used to control the altitude control of space craft and the flow and mixture regulation of deicing aircraft. Automative applications of fuzzy logic applications include idle speed control, shift scheduling for automatic transmissions, intelligent high systems, and traffic control. In electronic, fuzzy logic applications can be used for the control of the automatic exposure in a camera, humidity in a clean room, air conditioning systems, washing machine timing, microwave ovens, and vacuum cleaners. In another example, fuzzy logic applications are used in autonomous agentic AI systems, where software AI agents are consuming/producing qualitative data that can be processed by the fuzzy logic application.

In a typical fuzzy logic application, input variables of a controlled system are evaluated against fuzzy set definitions and fuzzy rules to generate adjustment variables for the controlled system. These fuzzy set definitions are static. However, the fuzzy set definitions are based upon conditions that can be dynamic, and no current fuzzy logic applications accounts for these dynamic changes.

### SUMMARY

A method is performed by a computer hardware fuzzy logic system including a controlled system and a fuzzy logic application configured to control the controlled system. A dataset defined by a period of time is retrieved from a store of historical input values for the controlled system. K clusters are generated from the dataset, and new fuzzy set definitions are generated for the K clusters. The fuzzy logic application updates old fuzzy set definitions with the new fuzzy set definitions. The fuzzy logic application also generates variable adjustments to the control system using the new fuzzy set definitions and received input values for the controlled system. The controlled system is modified using the variable adjustments.

Additionally, the methodology includes a determination being made to adjust the period of time, and based upon the determination, an artificial intelligence system is employed to generate a different period of time. The clustering can be performed using an unsupervised learning algorithm, and the unsupervised learning algorithm can be a K-Means clustering algorithm. The store of historical input values receives the historical input values from the controlled system, and the controlled system is a part of a robotic process automation system.

A computer hardware fuzzy logic system includes a controlled system and a fuzzy logic application configured to control the controlled system. The computer hardware fuzzy logic system includes a hardware processor configured to initiate the following operations. A dataset defined by a period of time is retrieved from a store of historical input values for the controlled system. K clusters are generated from the dataset, and new fuzzy set definitions are generated for the K clusters. The fuzzy logic application updates old fuzzy set definitions with the new fuzzy set definitions. The fuzzy logic application also generates variable adjustments to the control system using the new fuzzy set definitions and received input values for the controlled system. The controlled system is modified using the variable adjustments.

Additionally, the system includes a determination being made to adjust the period of time, and based upon the determination, an artificial intelligence system is employed to generate a different period of time. The clustering can be performed using an unsupervised learning algorithm, and the unsupervised learning algorithm can be a K-Means clustering algorithm. The store of historical input values receives the historical input values from the controlled system, and the controlled system is a part of a robotic process automation system.

A computer program product comprises a computer readable storage medium having stored therein program code. The program code, which when executed by a computer hardware fuzzy logic system including a controlled system and a fuzzy logic application configured to control the controlled system, causes the computer hardware fuzzy logic system to perform the following. A dataset defined by a period of time is retrieved from a store of historical input values for the controlled system. K clusters are generated from the dataset, and new fuzzy set definitions are generated for the K clusters. The fuzzy logic application updates old fuzzy set definitions with the new fuzzy set definitions. The fuzzy logic application also generates variable adjustments to the control system using the new fuzzy set definitions and received input values for the controlled system. The controlled system is modified using the variable adjustments.

Additionally, the compute program product includes a determination being made to adjust the period of time, and based upon the determination, an artificial intelligence system is employed to generate a different period of time. The clustering can be performed using an unsupervised learning algorithm, and the unsupervised learning algorithm can be a K-Means clustering algorithm. The store of historical input values receives the historical input values from the controlled system, and the controlled system is a part of a robotic process automation system.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example architecture of a fuzzy logic system according to an embodiment of the present invention.

FIGS. 2A and 2B respectively illustrate exemplary fuzzy set definitions and fuzzy rules.

FIG. 3 is a block diagram illustrating a methodology of performing the adjustment of fuzzy set definitions using the architecture of FIG. 1 according to an embodiment of the present invention.

FIGS. 4A-4C illustrate an example technique for finding clusters from a dataset and generating fuzzy set definitions for the clusters according to an embodiment of the present invention.

FIG. 5 is a block diagram illustrating an example of a computer environment for implementing portions of the methodology of FIG. 3.

### DETAILED DESCRIPTION

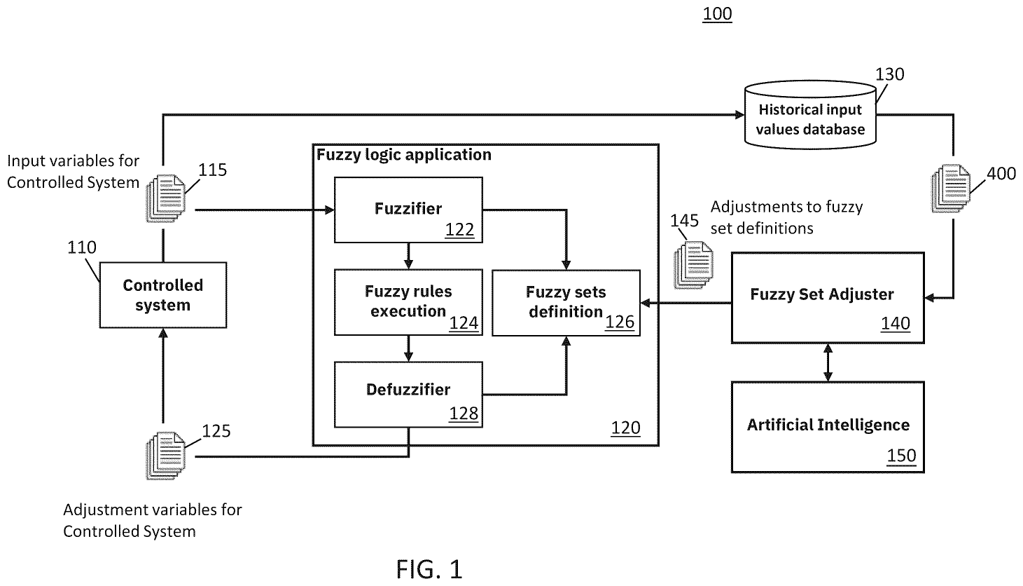

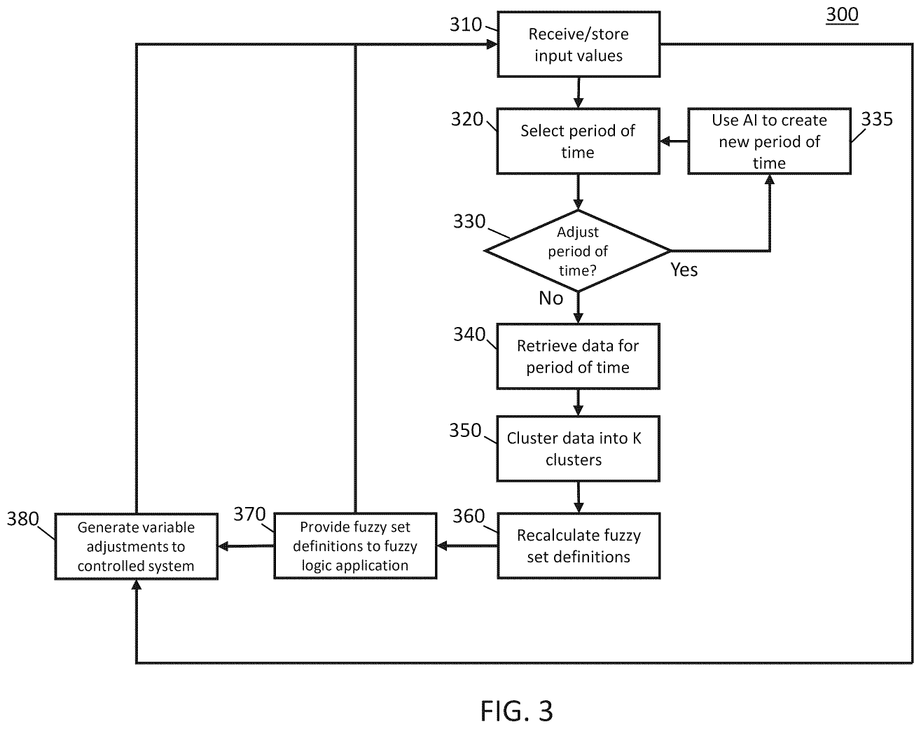

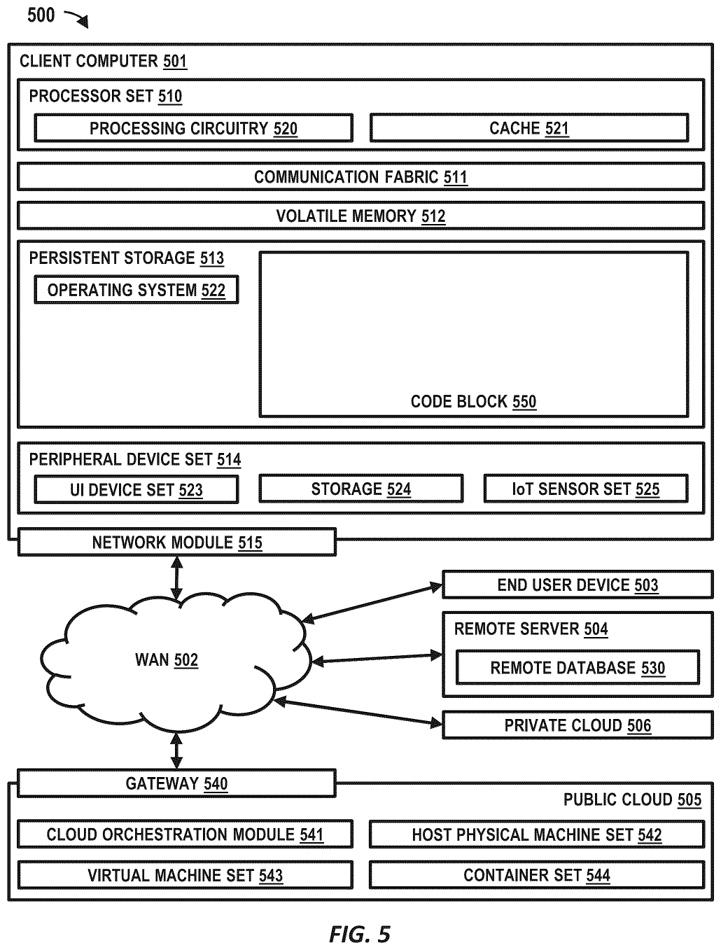

Referring to FIGS. 1 and 3, an exemplary fuzzy logic system 100 and methodology 300 of using the same is illustrated. Although not limited in this manner, the fuzzy logic system 100 controls the controlled system 110 using a fuzzy logic application 120, historical input values database (or store) 130, and a fuzzy set adjuster 140. Although the application 120, database 130, and adjuster 140 are illustrated as separated components, one or more of these components can be integrated together and/or provided as software as a service, as further described with regard to FIG. 5. Advantageously, the fuzzy logic system 100 provides an improvement over prior fuzzy logic systems by compensating for how the controlled system 110, and input variables 115 thereof, can change over time. For example, what may be considered “hot” one week, may be considered “warm” the next week. Consequently, the present fuzzy logic system 100 can account for possible drift in the variables that impact the controlled system 110 over time.

Although discussed in more detail with regard to FIG. 3, a dataset 400 defined by a period of time is retrieved from a store 130 of historical input values for the controlled system 110. a K number of clusters are generated from the dataset 400, and adjustments 145 to the fuzzy set definitions are generated for the K number of clusters using the fuzzy set adjuster 140. The fuzzy logic application 120 updates old fuzzy set definitions with the adjustments 145 to the fuzzy set definitions. The fuzzy logic application 120 also generates adjustment variables 125 to the control system 110 using the new fuzzy set definitions and received values of the input variables 115 for the controlled system 110. The controlled system 110 is then modified using the adjustment variables 125.

The controlled system 110 is not limited as to a particular type of hardware system. As discussed above, many types of controlled systems 110 are known that are controlled using fuzzy logic applications. However, in certain aspects, the controlled system 110 is part of a robotic process automation (RPA) system.

Fuzzy logic applications 120 are known and the fuzzy logic system 100 is not limited as to a particular type of fuzzy logic application. Although not limited in this manner, a typical fuzzy logical application 120 includes a fuzzifier 122, fuzzy logic rules execution 124, fuzzy set definitions 126, and a defuzzifier 128. As is known in the art, a fuzzifier 122 is a device that assigns the crisp numbers of the input variables 115 for the controlled system 110 into fuzzy sets with some degree of membership. This membership may be anywhere within the interval [0, 1], where 0 means that the value does not belong to a particular fuzzy set, 1 means that the value fully belongs within the particular fuzzy set, and any value between 0 and 1 means that the value partially belongs within the particular fuzzy set.

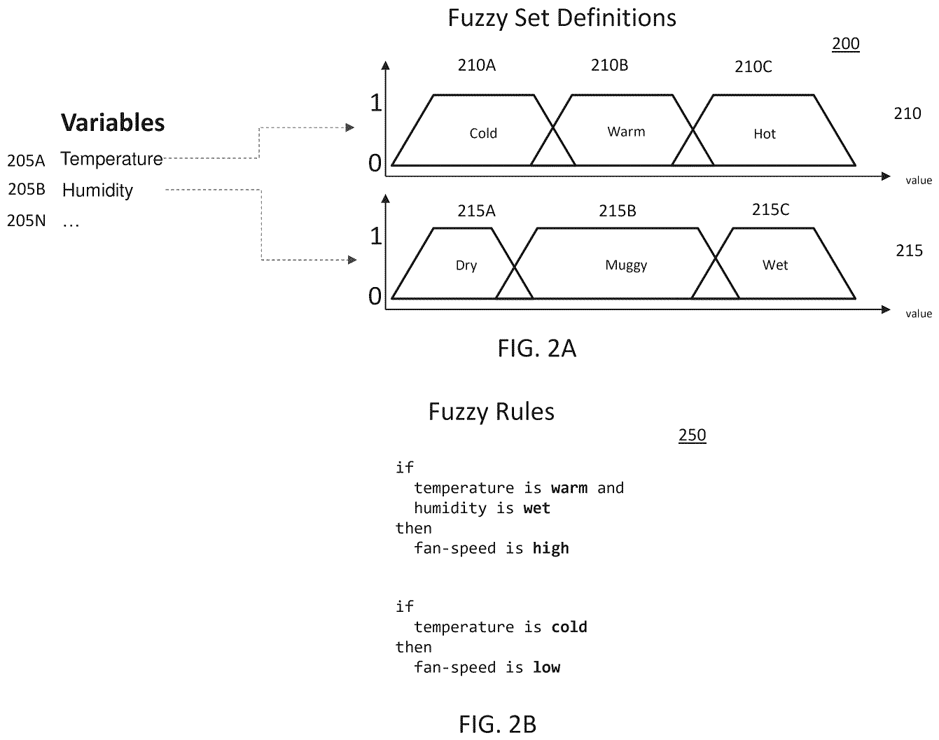

Reference is made to FIG. 2A, which illustrates individual instances 210, 215 of fuzzy set definitions 126 that can be used to determine the membership of values of variables 205A, 205B. As illustrated, a typical fuzzy set definition 210 for a particular variable 205A (e.g., temperature) includes a plurality of sets (e.g., 210A, 210B, 210C). Depending upon the value of the variable 205A, the value of the variable 205A will be assigned to one or more of the sets 210A-C. In the example in which the variable 205A is temperature, the sets 210A-C, can be cold 210A, warm 210B, and hot 210C. As such, depending upon the value of the variable 205, the value could be within a single set (e.g., cold 210A) or a plurality of sets (e.g., both warm 210B and hot 210C). Although not limited in this manner, a fuzzy set is oftentimes defined as a triangle or trapezoid-shaped curves.

The fuzzy rules execution 124 employs fuzzy rules 250 to determine what actions are to be taken (e.g., in the form of adjustment variables), and an example of fuzzy rules are illustrated in FIG. 2B. The defuzzifier 128 performs defuzzification on the fuzzy output of the fuzzy rules execution 124 to generate a crisp value (e.g., the adjustment variables 125) for the controlled system 110. For example, the output of the fuzzy rules execution 124 may be “Decrease Pressure (15%), Maintain Pressure (34%), and Increase Pressure (72%).” In this instance, the defuzzification process takes this output and converts it into a crisp variable (e.g., a pressure setting) that will be then provided to the controlled system 110. Many types of defuzzification processes are known, and the present defuzzifier 128 is not limited as to a particular approach.

With reference to FIG. 3, an overview of the general process 300 for employing the fuzzy logic system 100 is disclosed. Typically, the values of input variables 115 are generated with respect to the controlled system 110 and sent to the fuzzy logic application 120 for processing. In 310, the present fuzzy logic system 100 can take these same values of input variables 115 for the controlled system 110 and store them long-term within a historical input values database 130. Each value will also be assigned with a timestamp, and the manner in which this assignment of a timestamp is performed is not limited to any particular approach. In prior fuzzy logic systems, there would be no need for long-term storage of the values for the input variables. As used herein, the term “long-term storage” means storage other than that needed for the contemporaneously processing and analysis of the input variables that would normally be performed by a fuzzy logic application. For example, the short-term storage within cache does not constitute “long-term storage” within the meaning of the present disclosure.

In 320/330, the fuzzy set adjuster 140 selects a period of time that will be used to generate a dataset 400 from the historical input values database 130. In certain instances, the period of time is preset. However, in other instances, a determination can be made, in 330, to adjust the period of time. If so, the period of time can be adjusted to a new period of time. In certain instances, as illustrated with 335, the fuzzy set adjuster 140 may employ an artificial intelligence 150 to create the new period of time.

Although illustrated as being separate from the fuzzy set adjuster 140, the artificial intelligence 150 can also be a native aspect of the fuzzy set adjuster 140. The artificial intelligence 150 can be configured to use known reward functions to optimize the period of time. As will be subsequently discussed, the period of time is used to select the dataset 400 that will be subsequently used to generate adjustments 145 to the fuzzy set definitions 126. There may be instances in which, for example, the period of time is too long in which the short-term variations in the values of the input variables 115 are not captured early enough and accounted for. In another example, the period of time can be short, which do not allow any short-term variations in the values of the input variables 115 to manifest themselves. Over time, the artificial intelligence 150 can be used to optimize the period of time used to generate the dataset 400.

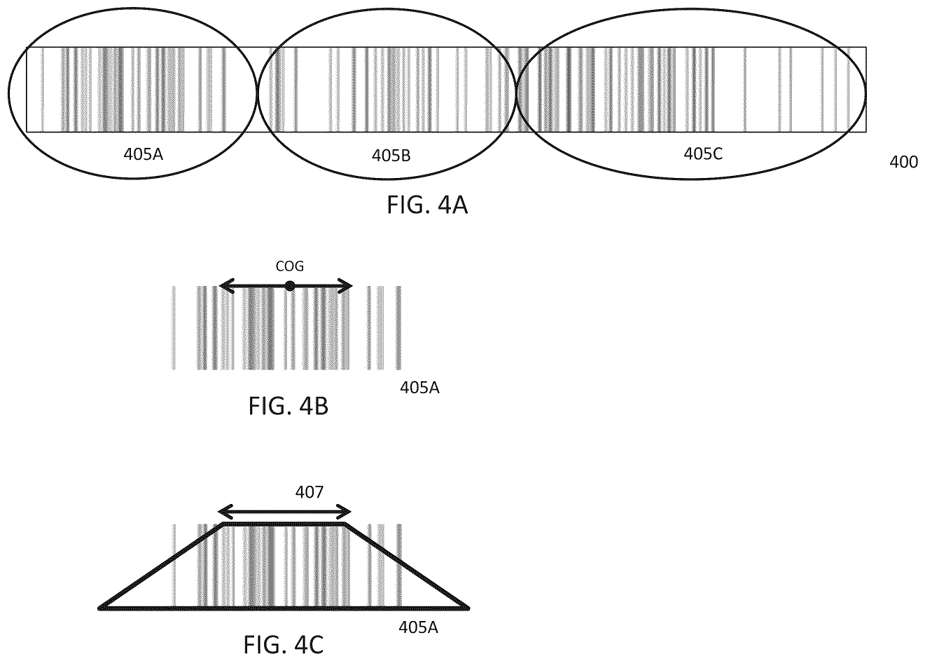

In 340, using the period of time, a dataset 400 of all the historical input values corresponding to the controlled system 110 and within the period of time is retrieved from the historical input values database 130. In 350, and also with reference to FIG. 4A, a plurality of clusters 405A-C are generated from the dataset 400. The generation of clusters 405A-C for a particular dataset 400 is known, and the fuzzy set adjuster 140 is not limited as to a particular approach. In certain instances, the fuzzy set adjuster uses an unsupervised learning algorithm. Many types of unsupervised learning algorithms are known. However, in certain aspects, the fuzzy set adjuster 140 uses a K-Means clustering algorithm.

In a K-means algorithm, a dataset comprising a number of datapoints is partitioned into a set of k clusters where each data point is assigned to its closest cluster. This particular methodology is defined by an objective function that tries to minimize the sum of all squared distances within a cluster and for all clusters.

In 360, and with reference to FIGS. 4B, 4C, adjustments 145 to the fuzzy set definitions 126 are determined. Although not limited in this manner, for a particular cluster, a center of gravity (COG) for the cluster 405A can be determined, as illustrated in FIG. 4B. Next, as illustrated in FIG. 4C, a predetermined amount 407 (e.g., one sigma) surrounding the center of gravity can define the scope of the cluster 405A for which values fully belong in the set. Other approaches of defining the fuzzy set definition for a particular cluster 405A having a center of gravity are known, and the fuzzy set adjuster 140 is not limited as to a particular approach.

In 370, the fuzzy set adjuster 140 provides adjustments 145 to the fuzzy set definitions 126 to the fuzzy logic application 120. The manner in which these adjustments 145 are provided is not limited as to a particular approach. For example, the adjustments 145 can only include the changes that were made. Alternatively, the adjustments 1245 can include the entire new fuzzy set definitions 126 that will subsequently replace the old fuzzy set definitions.

In 380, the fuzzy logic application 120 uses the new fuzzy set definitions 126 (i.e., as modified/replaced by the adjustments 145), to generate adjustment variables 125 for the controlled system 110 according to known approaches of employing a fuzzy logic application 120 and as already discussed above. The controlled system 100 is then modified with the adjustment variables 125.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 5, computing environment 500 contains an example of an environment for the execution of at least some of the computer code involved in performing the inventive methods, such as code block 550 for implementing the operations of the fuzzy set system 100. Computing environment 500 includes, for example, computer 501, wide area network (WAN) 502, end user device (EUD) 503, remote server 504, public cloud 505, and private cloud 506. In certain aspects, computer 501 includes processor set 510 (including processing circuitry 520 and cache 521), communication fabric 511, volatile memory 512, persistent storage 513 (including operating system 522 and method code block 550), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. However, to simplify this presentation of computing environment 500, detailed discussion is focused on a single computer, specifically computer 501. Computer 501 may or may not be located in a cloud, even though it is not shown in a cloud in FIG. 5 except to any extent as may be affirmatively indicated.

Processor set 510 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In certain computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in code block 550 in persistent storage 513.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 511 is the signal conduction paths that allow the various components of computer 501 to communicate with each other. Typically, this communication fabric 511 is made of switches and electrically conductive paths, such as the switches and electrically conductive paths that make up busses, bridges, physical input/output ports and the like. Other types of signal communication paths may be used for the communication fabric 511, such as fiber optic communication paths and/or wireless communication paths.

Volatile memory 512 is any type of volatile memory now known or to be developed in the future. Examples include dynamic type random access memory (RAM) or static type RAM. Typically, the volatile memory 512 is characterized by random access, but this is not required unless affirmatively indicated. In computer 501, the volatile memory 512 is located in a single package and is internal to computer 501. In addition to alternatively, the volatile memory 512 may be distributed over multiple packages and/or located externally with respect to computer 501.

Persistent storage 513 is any form of non-volatile storage for computers that is now known or to be developed in the future. The non-volatility of the persistent storage 513 means that the stored data is maintained regardless of whether power is being supplied to computer 501 and/or directly to persistent storage 513. Persistent storage 513 may be a read only memory (ROM), but typically at least a portion of the persistent storage 513 allows writing of data, deletion of data and re-writing of data. Some familiar forms of persistent storage 513 include magnetic disks and solid state storage devices. Operating system 522 may take several forms, such as various known proprietary operating systems or open source Portable Operating System Interface type operating systems that employ a kernel. The code included in code block 550 typically includes at least some of the computer code involved in performing the inventive methods.

Peripheral device set 514 includes the set of peripheral devices for computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some aspects, storage 524 may take the form of a quantum computing storage device for storing data in the form of qubits. In aspects where computer 501 is required to have a large amount of storage (for example, where computer 501 locally stores and manages a large database) then this storage 524 may be provided by peripheral storage devices designed for storing very large amounts of data, such as a storage area network (SAN) that is shared by multiple, geographically distributed computers. Internet-of-Things (IoT) sensor set 525 is made up of sensors that can be used in IoT applications. For example, one sensor may be a thermometer and another sensor may be a motion detector.

Network module 515 is the collection of computer software, hardware, and firmware that allows computer 501 to communicate with other computers through a Wide Area Network (WAN) 502. Network module 515 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 515 are performed on the same physical hardware device. In other aspects (for example, aspects that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any Wide Area Network (for example, the internet) capable of communicating computer data over non-local distances by any technology for communicating computer data, now known or to be developed in the future. In some aspects, the WAN 502 ay be replaced and/or supplemented by local area networks (LANs) designed to communicate data between devices located in a local area, such as a Wi-Fi network. The WAN 502 and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In certain aspects, EUD 503 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504. As defined herein, the term “server” means a data processing system configured to share services with one or more other data processing systems.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other aspects, a private cloud 506 may be disconnected from the internet entirely (e.g., WAN 502) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 505 and private cloud 506 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A method, within and by a computer hardware fuzzy logic system including a controlled system and a fuzzy logic application configured to control the controlled system, comprising:
retrieving, from a store of historical input values for the controlled system, a dataset defined by a period of time;
generating K clusters from the dataset;
generating new fuzzy set definitions for the K clusters;
updating, within the fuzzy logic application, old fuzzy set definitions with the new fuzzy set definitions;
generating, by the fuzzy logic application and based upon received input values for the controlled system, variable adjustments to the control system using the new fuzzy set definitions; and
modifying the controlled system using the variable adjustments.

2. The method of claim 1, wherein
a determination is made to adjust the period of time.

3. The method of claim 2, wherein
based upon the determination, an artificial intelligence system is employed to generate a different period of time.

4. The method of claim 1, wherein
the clustering is performed using an unsupervised learning algorithm.

5. The method of claim 4, wherein
wherein the unsupervised learning algorithm is a K-Means clustering algorithm.

6. The method of claim 1 wherein
the store of historical input values receives the historical input values from the controlled system.

7. The method of claim 1, wherein
the controlled system is a part of a robotic process automation system.

8. A computer hardware fuzzy logic system including a controlled system and a fuzzy logic application configured to control the controlled system, comprising:
a hardware processor configured to initiate the following executable operations:
retrieving, from a store of historical input values for the controlled system, a dataset defined by a period of time;
generating K clusters from the dataset;
generating new fuzzy set definitions for the K clusters;
updating, within the fuzzy logic application, old fuzzy set definitions with the new fuzzy set definitions;
generating, by the fuzzy logic application and based upon received input values for the controlled system, variable adjustments to the control system using the new fuzzy set definitions; and
modifying the controlled system using the variable adjustments.

9. The system of claim 8, wherein
a determination is made to adjust the period of time.

10. The system of claim 9, wherein
based upon the determination, an artificial intelligence system is employed to generate a different period of time.

11. The system of claim 8, wherein
the clustering is performed using an unsupervised learning algorithm.

12. The system of claim 11, wherein
wherein the unsupervised learning algorithm is a K-Means clustering algorithm.

13. The system of claim 8 wherein
the store of historical input values receives the historical input values from the controlled system.

14. The system of claim 8, wherein
the controlled system is a part of a robotic process automation system.

15. A computer program product, comprising:
a computer readable storage medium having stored therein program code,
the program code, which when executed by a computer hardware fuzzy logic system including a controlled system and a fuzzy logic application configured to control the controlled system, causes the computer hardware fuzzy logic system to perform:
retrieving, from a store of historical input values for the controlled system, a dataset defined by a period of time;
generating K clusters from the dataset;
generating new fuzzy set definitions for the K clusters;
updating, within the fuzzy logic application, old fuzzy set definitions with the new fuzzy set definitions;
generating, by the fuzzy logic application and based upon received input values for the controlled system, variable adjustments to the control system using the new fuzzy set definitions; and
modifying the controlled system using the variable adjustments.

16. The computer program product of claim 15, wherein
a determination is made to adjust the period of time.

17. The computer program product of claim 16, wherein
based upon the determination, an artificial intelligence system is employed to generate a different period of time.

18. The computer program product of claim 15, wherein
the clustering is performed using an unsupervised learning algorithm.

19. The computer program product of claim 18, wherein
wherein the unsupervised learning algorithm is a K-Means clustering algorithm.

20. The computer program product of claim 15, wherein
the store of historical input values receives the historical input values from the controlled system.
